(19) United States
(12) Patent Application Publication
(10) Pub. No.: US 2016/0124874 A1
(43) Pub. Date: May 5, 2016

(54) METHOD AND APPARATUS FOR INTERRUPT COALESCING

(71) Applicant: SanDisk Technologies Inc., Plano, TX (US)

(72) Inventor: Joseph Hassan, Ashkelon (IL)

(21) Appl. No.: 14/528,735

(22) Filed: Oct. 30, 2014

(51) Int. Cl. G06F 13/24

(52) U.S. Cl. CPC G06F 13/24

(57) ABSTRACT

Apparatus and methods implemented therein moderate the rate at which a peripheral device interrupts the operation of a host device. Moderation of interrupts is achieved by implementing interrupt coalescing schemes. In response to detecting an assertion of a first interrupt, a first time value from a free-running counter is read. A second time value is read from the free-running counter when an assertion of a second interrupt is detected. An identifier of the first interrupt is communicated to a host device when a sum of the first time value and an interrupt coalescing time period is equal to or greater than an instantaneous time read from the free-running counter. An identifier of the second interrupt is communicated to the host device when a sum of the second time value and an interrupt coalescing time period is equal to or greater than an instantaneous time read from the free-running counter.

### TECHNICAL FIELD

This application relates generally to communicating information between a host device and a peripheral device. More specifically, methods described herein relate to controlling the frequency at which the peripheral device interrupts the host device thereby reducing the operational overhead on the host device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Computing devices such as computers, digital cameras, printers, tablet computers, smart phones etc. are adapted with one or more electro-mechanical interfaces. Peripherals devices may be connected to a computing device via the electro-mechanical interfaces. Peripheral devices may be controlled by the computing device and perform specialized functions and complex tasks. The computing device may command or instruct a specific peripheral device to perform a function or task.

In some scenarios, using a scheme called polling, after commanding a peripheral device to perform a function or task, the computing device may periodically check or query the peripheral device to determine the status of command. Polling exacts a computational toll on the computing device. To ameliorate the effects of polling, in other scenarios, the peripheral device may asynchronously interrupt the operation of the computing to report on the status of a command. However, frequent asynchronous interruption also affects the operation of the computing device.

### SUMMARY

According to one aspect, a method for coalescing interrupts performed in control circuitry of a peripheral device is disclosed. When an assertion of a first interrupt is detected, a first time value from a free-running counter is read. The first time value corresponds to a detection time of the first interrupt. When an assertion of a second interrupt is detected, a second time value is read from the free-running counter. The second time value corresponding to a detection time of the second interrupt. The second interrupt is from a different interrupt source than the first interrupt. When an instantaneous time read from the free-running counter is equal to or greater than a sum of the first time value and an interrupt coalescing time period, an identifier of the first interrupt is communicated to a host device via the bus interface of the peripheral device to a host device. When an instantaneous time read from the free-running counter is equal to or greater than a sum of the second time value and the interrupt coalescing time period an identifier of the second interrupt is communicated via the bus interface to the host device.

According to another aspect, when a first of a series of assertions of a first interrupt line is detected, a first instantaneous time value from a counting circuit of a peripheral device is determined. An identifier of a first interrupt is transmitted after a first time period from detecting the first of the series of assertions of the first interrupt line. When a first of a series of assertions of a second interrupt line is detected a second instantaneous time value from the counting circuit is determined. An identifier of a second interrupt is transmitted after a second time period from detecting the first of the series of assertions of the first interrupt line. The first time period is different from the second time period.

According to yet another aspect, a peripheral device configured to be coupled to a host device via a bus interface is disclosed. The peripheral device comprises a memory and an interrupt management unit (IMU). The IMU may include a free-running counter, an interrupt encoding unit, an adder and an interrupt generation unit. The interrupt encoding unit is configured to detect a first of a series of assertions of a first interrupt and a first of a series of assertions of a second interrupt. The adder is configured to read a first instantaneous time value from the free-running counter when the first of a series of assertions of the first interrupt is detected by the interrupt encoding unit and read a second instantaneous time value from the free-running counter when the first of the series of assertions of the second interrupt is detected. The interrupt generation unit is configured to generate a first interrupt after a first time period from the detection the first of the series of assertions of the first interrupt and a second interrupt after a second time period from detecting the first of the series of assertions of the second interrupt.

### BRIEF DESCRIPTION OF THE DRAWINGS

FIG. 1 illustrates a block diagram of host and peripheral device according to one embodiment.

FIG. 2 illustrates a block diagram of an example memory device that may implement interrupt coalescing methods described herein.

FIG. 3A illustrates an example physical memory organization of the memory in the memory device of FIG. 1.

FIG. 3B shows an expanded view of a portion of the physical memory of FIG. 2.

FIG. 4 is a block diagram of an example interrupt management unit of memory device of FIG. 2 that may implement an interrupt coalescing scheme.

FIG. 5 is a block diagram of another example interrupt management unit of memory device of FIG. 2 that may implement another exemplary interrupt coalescing scheme.

FIG. 6 illustrates a flow diagram of an exemplary method for performing interrupt coalescing in accordance with an embodiment.

FIG. 7 illustrates a timing diagram that illustrates an interrupt coalescing scheme where occurrences of a first and second interrupt are coalesced by the same coalescing time period.

FIG. 8 is a timing diagram that illustrates an interrupt coalescing scheme where occurrences of a first and second interrupt are coalesced by different coalescing time periods.

### DETAILED DESCRIPTION

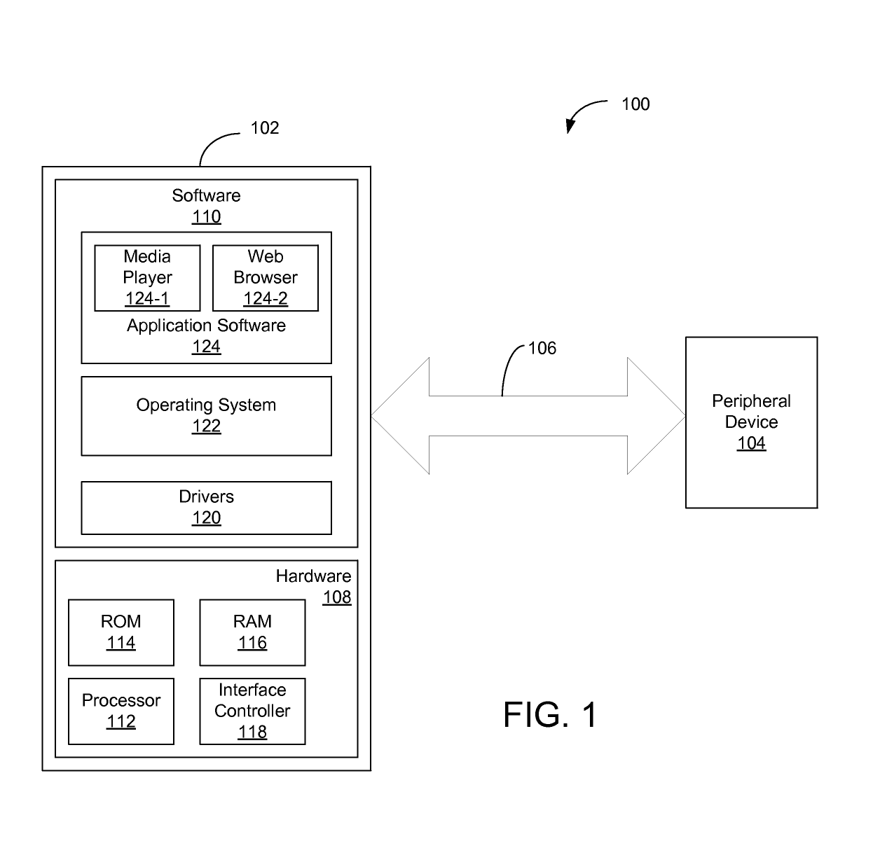

System 100 depicted in FIG. 1 may include apparatuses that implement methods for moderating the rate at which peripheral device 104 interrupts the operation of host device 102. A non-limiting list of reasons why peripheral device 104 may interrupt the operation of host device 102 include to communicate data in response to a request for data from host device 102 and to communicate status information about the operational status of peripheral device 104 to host device 102.

A non-exhaustive list of examples of host device 102 includes tablet computers, smart phones, laptop computers, printers, scanners and digital cameras. A non-exhaustive list of examples of peripheral device 104 includes storage devices like solid-state storage devices (SSD) which may be embedded in a host or removable, as well as network devices like wireline and wireless communication cards, and displays. By way of example and without limitation, host device 102 is electrically and mechanically connected to a single peripheral device 104. Arrangements that include a host device 102 communicatively coupled to multiple peripheral devices are contemplated.

In the system 100, host device 102 and peripheral device 104 communicate data and status information via bus interface 106. Generally a bus interface consists of one or more electrical conductors or lines. In an embodiment, bus interface 106 comprises electrical conductors and mechanical componentry that may be used to electrically and mechanically connect host device 102 with peripheral device 104. Bus interface 106 may comply with a set of well-known mechanical and electrical industry standards or may be proprietary. Small Computer System Interface (SCSI), Personal Computer Memory Card International Association (PCMCIA), Peripheral Component Interconnect Express (PCIe), Universal Serial Bus (USB) and IEEE 1394 are examples of industry standard bus interfaces. The bits that comprise data or status information are communicated in parallel over a parallel bus. The bits that comprise data words or status information are communicated serially over a serial bus. PCIe is an example of a serial bus.

In an embodiment, peripheral device 104 may be removably connected to host device 102. Examples of removably connected peripheral devices include PCMCIA card type SSD, USB flash drives, PCI express compliant network cards etc. In another embodiment, peripheral device 104 may be embedded within the host device 102 such that peripheral device 104 cannot be easily removed from host device 102. Examples of embedded peripheral devices include on-board WiFi communication devices, on-board SSD etc.

Host device 102 comprises hardware 108 and software 110. Hardware 108 is the collection of physical elements and componentry that constitutes host device 102. In this embodiment, by way of example and without limitation, hardware 108 comprises processor 112, read only memory (ROM) 114, random access memory (RAM) 116 and interface controller 118.

Interface controller 118 may comprise componentry that causes the bus interface 106 to operate in conformance with a bus interface standard. For example, if bus interface 106 operates in accordance with the USB standard, interface controller 118 may include a USB controller that may operate the bus interface 106 in compliance with the USB 3.0 standard for example. Similarly if bus interface 106 operates in accordance with the PCIe standard, interface controller 118 may include a PCIe transceiver that may operate the bus interface 106 in compliance with the PCIe standard.

Generally, software 110 comprises software instructions that when executed by processor 112 cause the host device 102 to function in accordance with the executed software instructions. The software 110 may be stored in ROM 114 or other memory locations in hardware 108. Processor 112 may fetch the software instructions from ROM 114 and execute the fetched instructions.

By way of example and without limitation, software 110 may be functionally and logically organized as software drivers 120, operating system 122 and application software 124. In this example and without limitation, application software 124 has two applications 124-1 and 124-2. Generally, software instructions comprising an application 124-1, such as a media application for example, when executed by processor 112 cause host device 102 to perform a particular action or task. Examples of software applications include web-browsers, text editors, media players, social media applications etc. Operating system 122 (OS) is a collection of software instructions that when executed by processor 112 manage software resources and provides common services for applications. ANDROID, IOS, WINDOWS 8, VxWORKS, UCOS etc. are examples of operating system 122. Software drivers comprise software instructions that when executed by processor 112 cause the control and operation of peripheral devices, peripheral device 104 for example, via bus interface 106. Drivers also comprise software instructions that when executed by processor 112 cause the control and operation of interface controller 118.

In an exemplary embodiment, peripheral device 104 may generate an interrupt signal also referred to as an interrupt whenever an event is generated in peripheral device 104. Events may be generated for various reasons during operation of peripheral device 104 and serve to convey operational status information to host device 102. Also, when peripheral device 104 is instructed by host device 102 to perform commands, elements of peripheral device 104 may also generate events in response to performing actions corresponding to the commands. The interrupt signal may be communicated to host device 102 via an interrupt line of bus interface 106. In response to receiving the interrupt signal, host device 102 may interrogate peripheral device 104 for information of the event that caused the interrupt. Based on the information of the event, host device 102 may perform the appropriate computational steps to clear the event. In an embodiment, peripheral device 104 may provide a mechanism which allows host device 102 to moderate the rate at which the peripheral device 104 interrupts host device 102.

In an exemplary embodiment, host device 102 may be a smart phone and peripheral device 104 may be a removable SSD. In this embodiment, in one scenario, a user may instruct media player 124-1 to playback a user-selected media file stored in peripheral device 104. Media player 124-1 may generate a file open request with a reference to the user-selected media file and communicate the file open request to OS 122. Media player 124-1 may suspend operation until the user-selected media file is received.

OS 122 may instruct a software driver 120 for peripheral device 104 to produce the appropriate command, a read request command for example, instructing the peripheral device 104 to retrieve the user-selected media file. The software driver for interface controller 118 may conform the read request command to comply with the standards of the bus interface 106 and cause the transmission of the compliant command to the peripheral device 104 via bus interface 106. Conforming a command comprises formatting the command to comply with the standards of the bus interface.

Peripheral device 104 may retrieve portions of the requested media file and communicate portions of the media file to host device 102 via bus interface 106. During the process of retrieving and communicating portions of the media file, peripheral device 104 may generate interrupts corresponding to particular events in the peripheral device.

In an embodiment, retrieving a portion of the requested media file may cause elements of the peripheral device 104 to generate a “read complete” event, for example. In response, peripheral device 104 may generate an interrupt signal that may be communicated over an interrupt line of the bus interface 106 to the host device 102. Thus for example if the requested media file comprises “N” portions, peripheral device 104 may generate an interrupt signal for each one of the “N” retrieved portions. Additional interrupts may be generated for other peripheral device-specific conditions.

The processor 112 may respond to the interrupt by suspending an executing application, saving the state of the suspended application, and executing a small program called an interrupt handler (or interrupt service routine, ISR) to handle the interrupt. Handling the interrupt may include querying the peripheral device for information of the event that caused the interrupt. In an embodiment, in response to determining that a “read complete” event caused the interrupt, processor 112 may execute portions of the drivers 120 that cause the retrieved portion of the requested media file to be transferred from peripheral device 104 to RAM 116 via bus interface 106. After the interrupt handler finishes handling the interrupt, the processor 112 may resume execution of the suspended application. Suspending and resuming execution of applications introduces a computational overhead and frequent interruption of the operation of the host device 102 by interrupts may cause host device 102 to operate inefficiently.

In an exemplary embodiment, peripheral device 104 provides a mechanism that allows host device 102 to moderate the rate at which interrupts are generated and communicated to host device 102 in response to alerts or events that are generated during operation of peripheral device 104. Moderating the rate at which interrupts are generated may be referred to as interrupt aggregation, interrupt coalescing or interrupt moderation.

In one interrupt coalescing scheme, peripheral device 104, in response to detecting an alert or event, may delay by a specified time the generation of an interrupt in response to a detected alert or event. Furthermore, if the same event was previously detected during a preceding time period corresponding to the specified time, peripheral device 104 may disregard the event. Disregarding the interrupt for the specified time period may be referred to as masking or inhibiting the interrupt or interrupt inhibition. The time period may be specified by the host device 102. The time period may be referred to as the interrupt (IRQ) coalescing time period. For example, in response to detecting a first “read complete” event peripheral device 104 may delay generation of an interrupt for the specified time. Separately, any subsequent “read complete” events generated may be disregarded by peripheral device 104 for the specified time. After detecting an expiration of the specified time, peripheral device 104 may generate an interrupt.

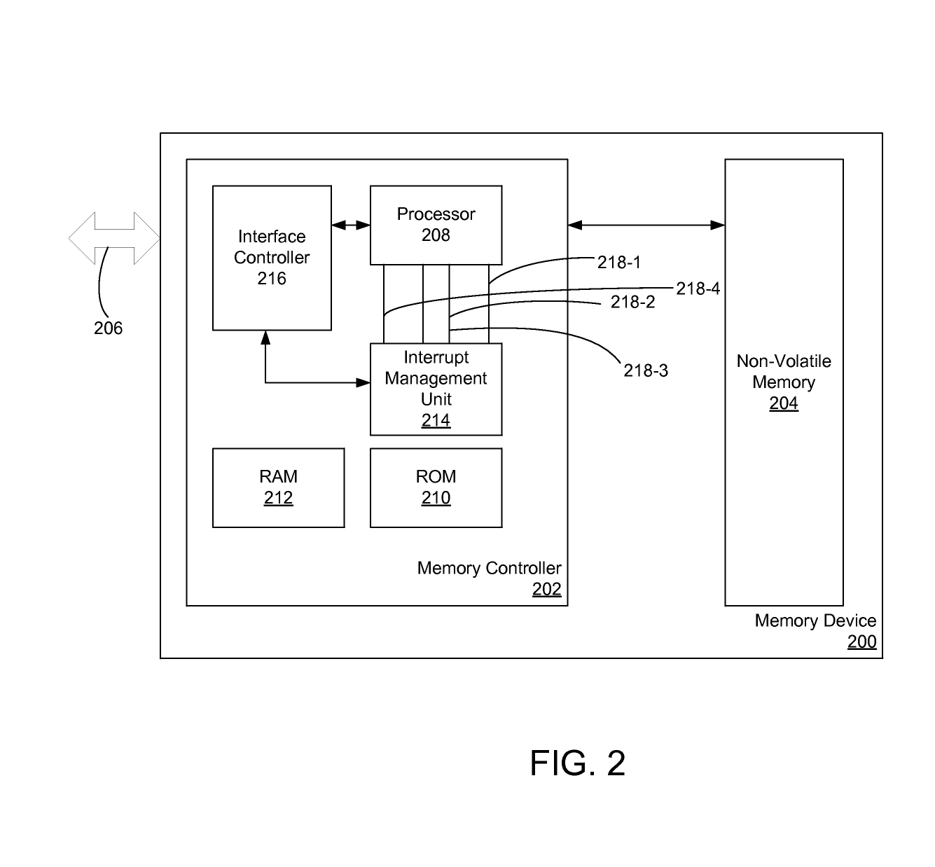

FIG. 2 is a block diagram of an exemplary memory device 200 that may implement an interrupt coalescing scheme. Memory device 200 may correspond to the exemplary peripheral device 104 of FIG. 1. By way of example and without limitation, memory device 200 comprises a memory controller 202 and non-volatile memory (NVM) 204, which may be any of a number of types of non-volatile memory such as NAND flash memory. Memory controller 202 communicates with host device 100 via bus interface 206. Bus interface 206 may correspond to bus interface 106 of FIG. 1. In an embodiment, memory controller 202 comprises processor 208, read only memory (ROM) 210, random access memory (RAM) 212, interrupt management unit (IMU) 214 and interface controller 216. The processor 202 may comprise a microprocessor, a microcontroller, an application specific integrated circuit (ASIC), a field programmable gate array, a logical digital circuit, or other now known or later developed logical processing capability. ROM 210 may store software instructions that processor 202 may execute to control the operation of NVM 204 and perform one or more steps of the interrupt coalescing schemes discussed herein.

Host device 100 may command memory controller 202 of the memory device 200 via bus interface 206 to store a data file such as a media file or a document file in NVM 204, read a data file from NVM 204, erase a data file from NVM 204 and so on.

In an embodiment, bus interface 206 and interface controller 216 are configured to operate in accordance with the NVMe standard that is adapted from the PCIe standard. In this embodiment, a command communicated by host device 100 may be formatted by interface controller 118 of host device 102 to conform to the NVMe standard. In response to receiving the formatted command, interface controller 216 may extract the command information from the formatted command and communicate the command to processor 208. In response to receiving the command, processor 208 of memory controller 202 may execute instructions stored in ROM 210 that cause processor 208 to act in accordance with the command. In response to acting in accordance with the command, processor 208 may activate or assert one of interrupt lines 218-1 to 218-4 to indicate the completion status of the command.

For example, processor 208 may assert interrupt line 218-1 to indicate the completion status of a command to read a data file from NVM 204, interrupt line 218-2 to indicate the completion state of a command to write a data file to NVM 204, interrupt line 218-2 to indicate the completion state of a command to erase a data file from NVM 204 and assert interrupt line 218-3 asynchronously to indicate to the host device 102 an error or abnormal operating condition. Thus, the interrupt lines are asserted in response to detecting different events. In another embodiment, the interrupt lines may be asserted by different respective interrupt sources. By way of example and without limitation, in the embodiment of FIG. 2, four interrupt lines 218-1 to 218-4 are depicted. Embodiments with greater or lesser numbers of interrupt lines, for example embodiments with several thousand interrupt lines, are contemplated.

As previously discussed, interface controller 216 of memory controller 202 receives commands from host device 102 via bus interface 206 and communicates data, interrupts and status to host device 102 via bus interface 206. The received commands may be decoded by interface controller 216. Similarly, interface controller 216 may encode data, interrupts and status in accordance with the standards of bus interface 206. In an embodiment, a command may include the interrupt (IRQ) coalescing time period. In this embodiment, interface controller 216 may decode the interrupt (IRQ) coalescing time period and communicate the interrupt (IRQ) coalescing time period to the processor 208. Processor 208 may store the interrupt (IRQ) coalescing time period in IMU 214.

IMU 214 may implement steps of the interrupt coalescing schemes discussed herein. For example, IMU 214 receives interrupts signals 218-1 to 218-4 from processor 208 and communicates the interrupt to host device 102 via interface controller 216 and bus interface 206. In an exemplary embodiment, IMU 214 may delay the communication of a received interrupt and subsequently received interrupts for a time period, interrupt (IRQ) coalescing time period, as specified by the host device 102.

For example, in case of request to read a data file stored in NVM 204, interface controller 216 may extract the read command and communicate the read command and associated information to processor 208. The associated information may include the offset of the start of the data file in NMV 204 and the size of the data file. Processor 208 may read the data file from NVM 204 and transmit the data file via bus interface 206 to host device 102. As previously discussed, processor 208 may read the data file in several discrete portions.

In an exemplary embodiment, in response to reading a discrete portion of the requested data file, processor 208 may cause IMU 214 of memory controller 202 to generate and communicate an interrupt to the host device 100 via bus interface 206. For example, in response to reading a portion of the requested data file, processor 208 may assert or activate interrupt line 218-1 to indicate that the reading of a portion of the requested data file is complete. In response to detecting the activation of interrupt line 218-1, in one embodiment, IMU 214 may implement the previously discussed interrupt coalescing scheme. In this embodiment, host device 102 may instruct IMU 214 to delay the generation of an interrupt for a specified time period. Additionally, host device 102 may instruct IMU 214 to aggregate occurrences of the interrupt for the specified time period. In response to being instructed by processor 208 to generate an interrupt 218-1 for example, IMU 214 may delay the generation of the interrupt for the specified time period. Subsequent activations of the interrupt line 218-1 as other portions of the requested data file are read are ignored by the IMU 214 for the specified time period. After expiration of specified time period, IMU 214 may communicate a single instance of the interrupt 218-1 to host device 102 via bus interface 206.

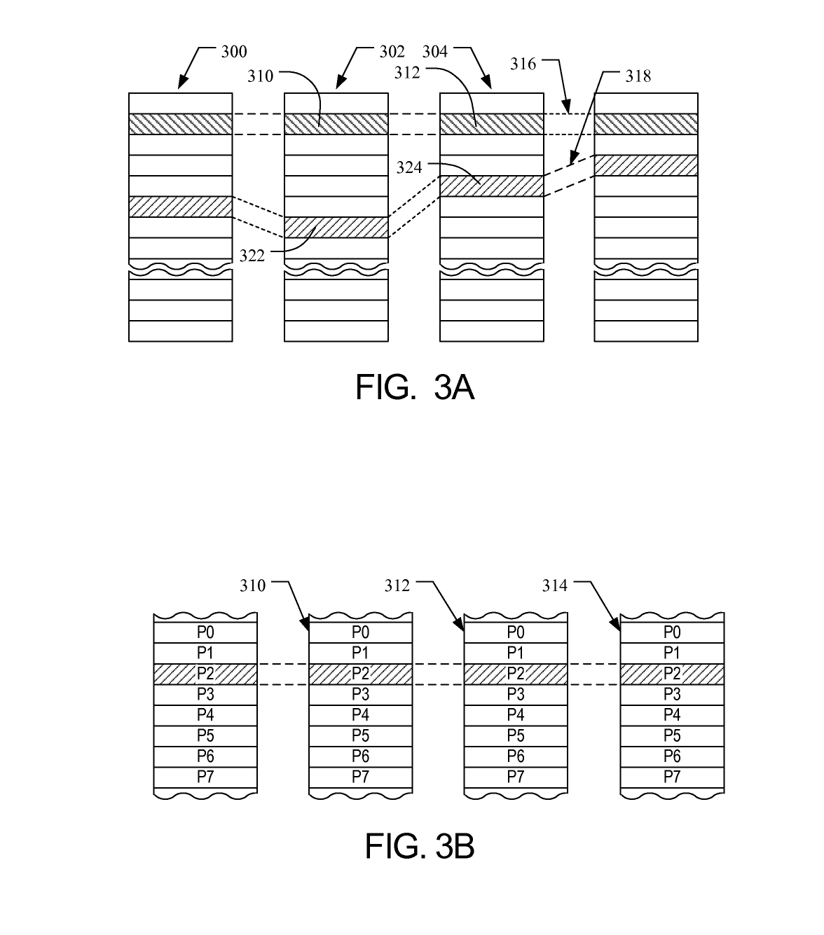

Referring to FIG. 3A, non-volatile memory 204 of FIG. 2 may be arranged in memory chunks comprising a group of single-level memory cells (SLC) or multi-level memory cells (MLC). An SLC can store a single bit of data per cell. An MLC can store multiple bits of data per cell. For example, a two-level MLC can store two bits of data per cell, a three level MLC can store 3 bits of data per cell and N level MLC memory can store N bits of data per cell. Typical sizes of memory chunks are 4096 bytes or 4 Kilobytes (Kbytes). In the example of FIG. 3A, four planes or sub-arrays 300, 302, 304 and 306 of memory chunks are shown that may be on a single integrated memory cell chip, on two chips (two of the planes on each chip) or on four separate chips. The specific arrangement is not important to the discussion below and other numbers of planes may exist in a system. The planes are individually divided into pages shown in FIG. 3A by rectangles, such as pages 308, 310, 312 and 314, located in respective planes 300, 302, 304 and 306. There may be dozens or hundreds of pages in each plane.

Pages may be logically linked together to form a memory block may be erased as a single unit. For example, pages 308, 310, 312 and 314 may form a first memory block 316. The pages used to form a memory block need not be restricted to the same relative locations within their respective planes, as is shown in the second memory block 318 made up of pages 320, 322, 224 and 226.

As previously discussed, the individual pages are in turn divided for operational purposes into memory chunks of memory cells, as illustrated in FIG. 3B. The memory cells may be SLC or MLC type cells. The memory chunks of each of pages 308, 310, 312 and 314, for example, are each divided into eight chunks P0-P7. Alternately, there may be 16, 32 or more memory chunks of memory cells within each block. A memory chunk is the unit of data programming and reading within a page, containing the minimum amount of data that are programmed or read at one time. A memory plane 302 is illustrated in FIG. 3B is formed of one physical page for each of the four pages 308, 310, 312 and 314. The memory blocks disclosed in FIGS. 3A-3B are referred to herein as physical blocks because they relate to groups of physical memory cells as discussed above. As previously discussed and as used herein, a logical block is a virtual unit of address space defined to have the same size as a page. Each logical block includes a range of logical block addresses (LBAs) that are associated with data received from a host 100. The LBAs are then mapped to one or more memory chunks in the storage device 102 where the data is physically stored.

Based on the size of a data file stored in non-volatile memory 204, a data file may occupy several memory chunks. In an embodiment, memory controller 202, in response to receiving a request from host device 102 to write a data file to non-volatile memory 204, may identify memory chunks that were not previously written to and may write portions of the data file to respective memory chunks. In response to completing the write of a portion of the data file to a respective memory chunk, processor 208 may assert interrupt line 218-2. IMU 214 may detect the assertion of the interrupt line 218-2 and delay the generation of the interrupt.

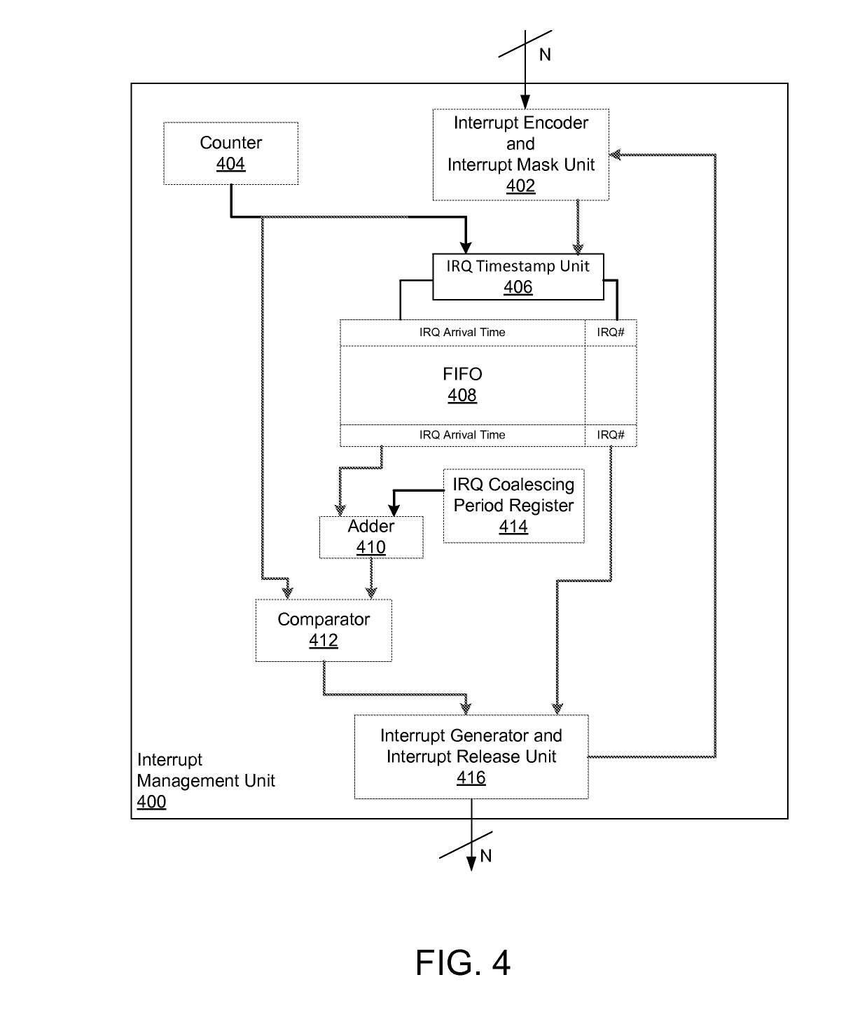

FIG. 4 is a detailed block diagram of an example IMU 400 that may be implemented in memory controller 202 (FIG. 2). The example IMU 400 may correspond to the IMU 214 of FIG.2. By way of example and without limitation, some or all the elements of the IMU 400 may be implemented by software, hardware componentry or a combination thereof.

In an embodiment, IMU 400 stores the Interrupt (IRQ) coalescing time period in the IRQ coalescing period register 414. The IRQ coalescing time period is the time period by which the IMU 400 delays communicating to the host device 102, the occurrence of the interrupt. The IRQ coalescing time period also corresponds to the time period that IMU 400 aggregates repeated assertions of the same interrupt signal. IRQ coalescing period register 414 may be implemented as a hardware register or as a software variable. As previously discussed, host device 102 may communicate the IRQ coalescing time period to peripheral device 104 via bus interface 106. In response to receiving the IRQ coalescing time period, processor 208 may program the IRQ coalescing period register 414 with the received IRQ coalescing time period.

Counter 404 is configured to generate a time value or count of elapsed time from an arbitrary point in time. In an embodiment, counter 404 may comprise a clock source such as an oscillator and a frequency synthesizer. The frequency synthesizer may be programmed by processor 208 to cause the frequency synthesizer to produce a clock signal of the appropriate time period/frequency. For example, the processor 208 may program the frequency synthesizer to generate a clock signal with a frequency of 1 MHz (1 microsecond time period). The clock signal may be used to drive a free running counter. In an embodiment, a 32 bit counter may be employed. The count of the free running counter may increment for each transition of the clock signal. In the example of a clock signal of 1 MHz, the count in the counter will increment every 1 microsecond. Thus, after 1 second, the time value or count reflected in the counter will be 1000000. The counter may be reset to zero after the count in the counter reaches its maximum value. In case of a 32 bit counter, the counter will be reset after the count reaches 2̂32 −1 or 4294967295 decimal or 0xFFFFFFFF hexadecimal.

In an embodiment, processor 208 may compute the value to be programmed in counter 404 based on the received IRQ coalescing time period. The counter 404 may be programmed such that the frequency or rate at which the counter 404 increments is an order of magnitude of the received IRQ coalescing time period. For example, if received IRQ coalescing time period is 1 milliseconds or 1 KHz, the counter 404 may be programmed to increment at a frequency of 1 MHz or 10⁶ times per second or 1000 times the IRQ coalescing time frequency.

The interrupt encoder and interrupt mask unit 402 is configured to receive N interrupt lines from processor 208. By way of example and without limitation, in the discussion of FIG. 4N equals four and the interrupt encoder and interrupt mask unit 402 receives 4 interrupt lines, 218-1 to 218-4. Embodiments with any number of interrupt lines are contemplated. In an embodiment, the interrupt encoder and interrupt mask unit 402 may include combinational and sequential logic circuitry. Logic gate, encoders etc. are examples of combinational circuitry. Flip-flops, registers, etc. are examples of combinational circuitry. In another embodiment, the interrupt encoder and interrupt mask unit 402 may be implemented as software instructions that are stored in ROM 210 and executed by processor 208.

The interrupt encoder and interrupt mask unit 402 encodes a received interrupt and converts the received interrupt to a number. The interrupt encoder and interrupt mask unit 402 converts 2^{N} input signals to an N-bit coded output. For example, assuming interrupt line 218-1 is the least significant bit (0) of a four bit interrupt nibble 218 and interrupt line 218-4 is the most significant bit (3) of the four bit interrupt nibble 218, in response to detecting an assertion of interrupt line 218-4, the interrupt encoder and interrupt mask unit 402 may generate the number 3 (interrupt 3). Similarly, in response to detecting an assertion of interrupt line 218-3, the interrupt encoder and interrupt mask unit 402 may generate the number 2 (interrupt 2). Similarly, in response to detecting an assertion of interrupt line 218-1, the interrupt encoder and interrupt mask unit 402 may generate the number 0 (interrupt 0). The following table depicts the encoding for an exemplary 4 to 2 encoder that may be implemented in the interrupt encoder and interrupt mask unit 402 of FIG. 2.

TABLE 1

| Interrupt Line Asserted | Binary Input | Encoded Binary Output (HEX) |
|---|---|---|
| 218-1 | 0001 | 00 (0x00) |
| 218-2 | 0010 | 01 (0x01) |
| 218-3 | 0100 | 02 (0x02) |
| 218-4 | 1000 | 03 (0x03) |

In response to detecting the assertion of an interrupt line, the interrupt encoder and interrupt mask unit 402 in accordance with Table 1 may generate an interrupt number corresponding to the asserted interrupt line. The interrupt encoder and interrupt mask unit 402 may mask or inhibit the generation of the same interrupt number for period of time corresponding to the IRQ coalescing time period that is stored in IRQ coalescing period register 414. As previously discussed, the value of the time period stored in interrupt coalescing period register 404 may be specified by the host device 102. In an embodiment, masking the interrupt may include operating logic elements in the interrupt encoder and interrupt mask unit 402. In another embodiment, masking the interrupt may include setting a software flag or semaphore indicating that the interrupt was received.

The IRQ timestamp unit 406 is configured to generate a data word comprising a timestamp and an interrupt number. In response to receiving a notification of an interrupt number from interrupt encoder and interrupt mask unit 402, IRQ timestamp unit 406 is configured to read the instantaneous time value or count presented by free running counter 404. The instantaneous time value corresponds to the count presented by free running counter 404 when assertion of the interrupt line, 218-1 for example, is detected. The IRQ timestamp unit 406 may concatenate the read count with the interrupt number to generate a data word. The resulting data word may be stored in the first free entry of a first in first out (FIFO) unit 408. The instantaneous time value in the data word corresponds to the interrupt (IRQ) arrival time or assertion time of the interrupt line corresponding to the received interrupt number. By way of example and without limitation, in an embodiment IRQ timestamp unit 406 may generate a 64 bit data word. In this embodiment, the most significant 32 bit may correspond to the instantaneous time value or count read from free running counter 404 and the lower 32 bit may hold the interrupt number.

FIFO unit 408 is an “N” entry deep storage unit. Each entry comprises an interrupt number and the IRQ arrival time of the interrupt signal corresponding to the interrupt number. In an embodiment, the width of an entry may correspond to the width of the data word generated by the IRQ timestamp unit 406. In an embodiment, FIFO unit 408 may be implemented as a linked list of “N” entries in RAM 212. In this embodiment, an entry in the FIFO 408 may include a pointer or reference to the next entry. In another embodiment, FIFO unit 408 may be implemented as “N” hardware registers using suitable combinational and sequential logic elements.

Adder 410 is configured to retrieve the IRQ arrival time portion from the data word stored the entry of FIFO unit 408 corresponding to the earliest stored interrupt number. Adder 410 is also configured to read the coalescing time period specified in the interrupt coalescing period register 404. Finally, adder 410 is configured to add the retrieved IRQ arrival time with the coalescing time period specified in the interrupt coalescing period register 404. The output generated by adder 410 corresponds to the sum of the retrieved IRQ arrival time and the coalescing time period. In this embodiment, because the width of the IRQ arrival time portion is 32 bits, adder 410 may be implemented as a 32 bit adder. A 32 bit adder may be implemented with eight cascading 4-bit adders. The 74LS83 is an example of a 4-bit adder. In another embodiment, adder 410 may be implemented in software as an addition operation.

Comparator 412 reads the instantaneous time value presented by free running counter 404 and compares this time value with the output of adder 410. In response to detecting that the instantaneous time value presented by counter 404 is equal to or exceeds the output of adder 410, comparator 412 is configured to transmit a notification to interrupt generator and interrupt release unit 416.

The interrupt generator and interrupt release unit 416 is configured to receive the notification from comparator 412 and in response to receiving the notification is configured to retrieve, from the earliest stored entry in the FIFO unit 408, the corresponding interrupt number. The interrupt generator and interrupt release unit 416 may generate an interrupt signal via bus interface 206, in an embodiment. In response to generating the interrupt, interrupt generator and interrupt release unit 416 may unmask the generation of the same interrupt number. In an embodiment, unmasking the generation of the same interrupt may include communicating by the interrupt generator and interrupt release unit 416, a signal to interrupt encoder and interrupt mask unit 402. In response, interrupt encoder and interrupt mask unit 402 may unmask the interrupt. Unmasking the interrupt enables the interrupt encoder and interrupt mask unit 402 to respond to subsequent interrupt with the same number. For example, interrupt encoder and interrupt mask unit 402 may reset the flag or release the semaphore that was set or locked, when the interrupt was received.

In an embodiment, the interrupt generator and interrupt release unit 416 may communicate the identifier of the interrupt asserted interrupt line, 218-1 for example, to the host device. Additionally, the instantaneous time value corresponding to the count presented by free running counter 404 when assertion of the interrupt line, 218-1 for example, was detected may also be communicated to the host device. In another embodiment, to conserve bandwidth of the interface between the host and the peripheral device, the instantaneous time value communicated to the host device may be compressed. Compression of the instantaneous time value corresponding to the count presented by free running counter 404 may be achieved by only communicating significant bits. For example, if only the least significant 8 bits include all the information for the instantaneous time value, only these bits may be communicated with the identifier of the interrupt.

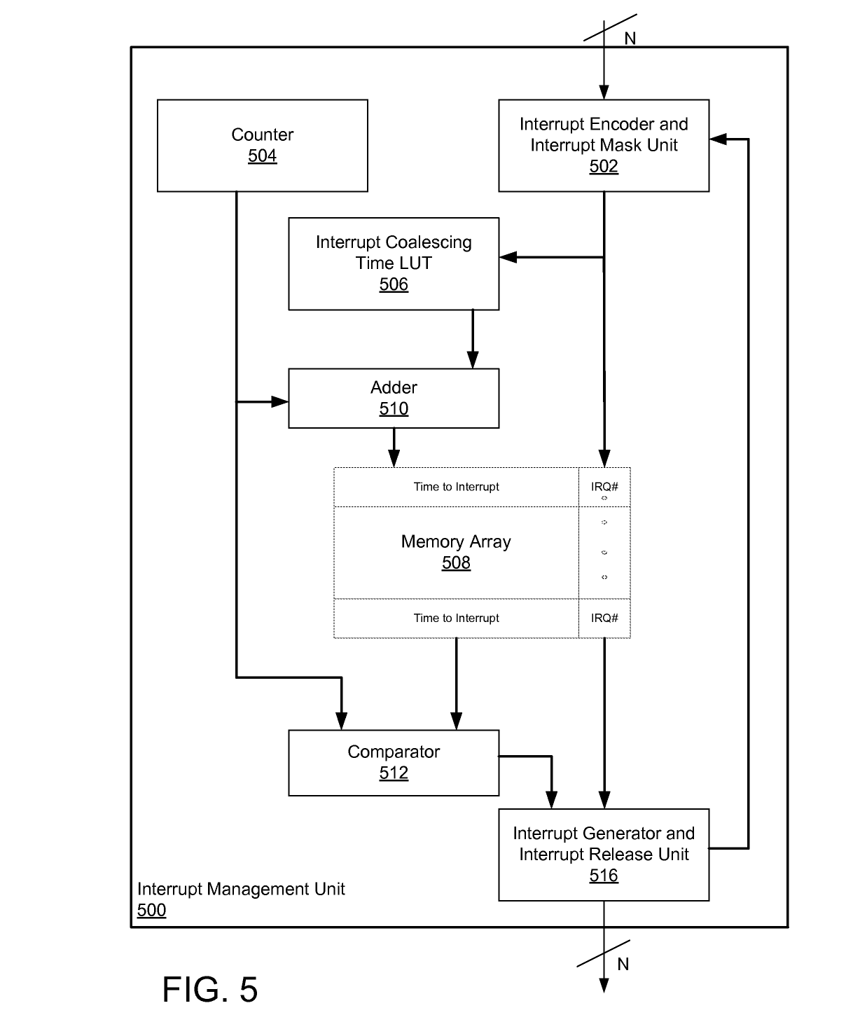

FIG. 5 is a detailed block diagram of another example IMU 500 that may be implemented in memory controller 202 (FIG. 2). The example IMU 500 may correspond to the IMU 214 of FIG. 2. By way of example and without limitation, some or all the elements of the IMU 500 may be implemented by software, hardware componentry or a combination thereof. In this embodiment, IMU 500 is adapted to receive from host device 102 different interrupt coalescing times to be applied to interrupts received by the interrupt encoder and mask unit 402. In another embodiment, IMU 500 is adapted to receive from host device 102 different interrupt coalescing times to be applied to subsets of interrupts received by interrupt encoder and mask unit 402. For example, a first interrupt coalescing time may be applied to interrupts 218-1 and 218-2 and a second interrupt coalescing time may be applied to interrupts 218-3 and 218-4.

In an embodiment, IMU 500 comprises an interrupt encoder and mask unit 502, counter 504, interrupt coalescing time look up table (LUT) 506, memory array 508, adder 510, comparator 512 and interrupt generator and interrupt release unit 516. By way of example and without limitation, some or all the elements of the IMU 500 may be implemented by software, hardware componentry or a combination thereof.

In an embodiment, interrupt coalescing time LUT 506 corresponds to an ordered array of entries of interrupt coalescing time periods that may be stored in RAM 212 of FIG. 2. In an embodiment, processor 208 may receive from host device 102 an interrupt coalescing time period and an associated interrupt number. For example, processor 208 may receive a packet of data from host device 102 that includes an interrupt number and a corresponding interrupt coalescing time period. Processor 208 may utilize the interrupt number as an index into interrupt coalescing time LUT 506 and processor 208 may store the received interrupt coalescing time period in interrupt coalescing time LUT 506 at a location corresponding to the interrupt number. Processor 208 may receive an interrupt coalescing time period for each one of the interrupts that may be received by interrupt encoder and interrupt mask unit 502. Processor 208 may store the each of the interrupt coalescing time period in the interrupt coalescing time LUT 506. For example, processor 208 may receive an interrupt coalescing time period, 1 millisecond for example, associated with interrupt 218-1 and may store 1 millisecond in the first entry of the interrupt coalescing time LUT 506. Similarly, in response to receiving a second time coalescing time period, 2 milliseconds for example, associated with interrupt 218-4, processor 208 may store a value corresponding to 2 milliseconds in the fourth entry of the interrupt coalescing time LUT 506.

As previously discussed with reference to FIG. 4, the interrupt encoder and interrupt mask unit 502 encodes a received interrupt and converts the received interrupt to a number. The interrupt encoder and interrupt mask unit 502 converts 2^{N} input signals to an N-bit coded output. Functional and logical components of the interrupt encoder and interrupt mask unit 502, may utilize the interrupt number as an index into the interrupt coalescing time LUT 506 and retrieve the interrupt coalescing time period stored at a location in the interrupt coalescing time LUT 506 corresponding to the interrupt number. The functionality of the interrupt encoder and interrupt mask unit 502 may correspond to the functionality of the interrupt encoder and interrupt mask unit 402 described with respect to FIG. 4.

In this embodiment, in response to receiving an interrupt, adder 510 is configured to read the instantaneous time value or count presented by free running counter 504. Further adder 510 is configured to add the interrupt coalescing time period retrieved from the entry of interrupt coalescing time LUT 506 corresponding to the interrupt number with the read instantaneous time value to generate a portion of a data word. This portion of the data word may be referred to as time to interrupt. The data word comprising the time to interrupt and the interrupt number may be stored into an entry in memory array 508 along with the interrupt number.

In an embodiment, memory array 508 comprises an array of entries of “N” data words. The array corresponding to memory array 508 may be located in RAM 212. Each time, a data word is added to the memory array 508, processor 508 may sort the data words based on the value of the time to interrupt portion of the data word. Thus, an interrupt number associated with the smallest absolute time to interrupt is moved to the top or front of the memory array 508. Memory array 508 may be organized as a linked list of data structures. One skilled in the art will recognize that a data structure in a linked list includes the stored data word a reference or pointer to the next data structure and a reference to the previous data structure. If the data structure is the first data structure, the reference to the previous data structure may be set to NULL. Sorting the data structures may include comparing the absolute time to interrupt of a first structure with the absolute time to interrupt for the data word associated with the next data structure and previous data structure. Based on the results of the comparison the references may be adjusted to sort the data structures. This method of sorting is frequently referred to as bubble sorting. Other methods of sorting memory array 508 are contemplated.

Comparator 512 reads the instantaneous time value presented by free running counter 504. Comparator 512 may retrieve the time to interrupt portion of the data word stored in the top of front of the memory array 508. Comparator 512 compares the time to interrupt with the instantaneous time value. In response to detecting that the Counter 504 is equal or exceeds the time to interrupt, comparator 512 is configured to transmit a notification to interrupt generator and interrupt release unit 516.

The interrupt generator and interrupt release unit 516 is configured to receive the notification from comparator 512 and in response to receiving the notification is configured to retrieve, from the earliest stored entry in the memory array 508, the corresponding interrupt number. The interrupt generator and interrupt release unit 516 may generate an interrupt signal via bus interface 206, in an embodiment. In response to generating the interrupt, interrupt generator and interrupt release unit 516 may unmask the generation of the same interrupt number. In an embodiment, unmasking the generation of the same interrupt may include communicating by the interrupt generator and interrupt release unit 516, a signal to interrupt encoder and interrupt mask unit 502. In response, interrupt encoder and interrupt mask unit 502 may unmask the interrupt. Unmasking the interrupt enables the interrupt encoder and interrupt mask unit 502 to respond to subsequent interrupt with the same number. For example, interrupt encoder and interrupt mask unit 502 may reset the flag or release the semaphore that was set or locked, when the interrupt was received.

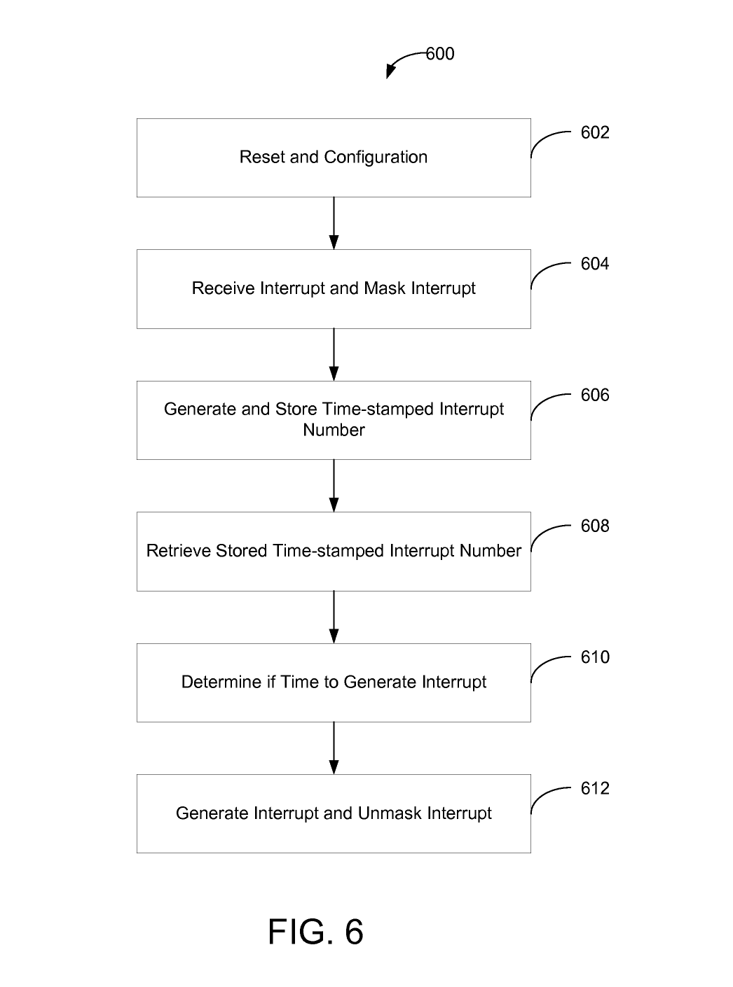

FIG. 6 is flow diagram of an example interrupt coalescing method 600 that may be implemented by a peripheral device 104 such as memory device 200, in accordance with an embodiment. Software instructions corresponding to some or all of the steps of method 600 may be stored in ROM 210, in an embodiment. Processor 208 may execute the software instructions to effectuate the functionality associated with the steps of method 600.

At block 602, memory controller 202 may receive a command from host device 102 to reset. The command to reset may be received via bus interface 206. In response, processor 208 may execute software instructions stored in ROM 210 to cause the initialization of hardware components of memory controller 202. Initializing may also include initializing a flag or semaphore for each of the respective interrupts, 218-1 to 218-4 for example. As previously discussed, a flag or semaphore may be associated with an interrupt to store the mask/unmask state of the interrupt. At block 602, all the flags may be unmasked. Separately, in some embodiments, at block 602, processor 208 may initialize the data structures required to implement the previously discussed interrupt coalescing schemes. For example, in the embodiment of FIG. 4, at block 602, processor 208 may initialize FIFO array 408. In the embodiment of FIG. 5, at block 602, processor 208 may initialize memory array 508 and interrupt coalescing time look up table (LUT) 506, for example.

At block 602, memory controller 202 may receive configuration information from host device 102. By way of example and without limitation, configuration information may include the interrupt coalescing time, in an embodiment. In response, the received interrupt coalescing time may be stored in IRQ Coalescing Period Register 414 (FIG. 4). In an embodiment, IRQ Coalescing Period Register 414 may correspond to a software variable or register that may be stored in RAM 208. Based on the value of the received interrupt coalescing time, processor 208 may compute a configuration value for counter 404 for example. The configuration value corresponds to the frequency or rate at which the count of counter 404 increments or decrements. Frequency and time period are inversely related to each other. Typically, a value that produces an increment rate or frequency that is 1000 times the inverse of the interrupt coalescing time may be selected. At block 602, counter 404 may be programmed to generate the desired frequency or rate.

In another embodiment, where the interrupts, 218-1, 218-2, 218-2 and 218-4 are each associated with a different interrupt coalescing time (FIG. 5), at block 602, memory controller 202 may receive from host device 102 information for the interrupt coalescing time for each of the interrupts. The information may be received as matched pairs of interrupt number and interrupt coalescing time. In response, processor 208 may parse the information store the received interrupt coalescing periods in interrupt coalescing time look up table (LUT) 506, in an embodiment.

At block 604, functionality associated with interrupt management unit 214 may cause the monitoring of interrupt lines, 218-1 to 218-4 for example. In an embodiment, interrupt management unit 214 may be implemented as executable software instructions. In this embodiment, processor 208 may perform the functionality associated with interrupt management unit 214. In response to detecting the assertion of an interrupt line, processor 208 may decode the interrupt line and generate an interrupt number associated with the interrupt line. The interrupt line, 218-1 for example, may be asserted in response to the completion of the execution of a command received from host device 102. At block 604, processor 208 may determine if the asserted interrupt is masked. Determining if the interrupt is masked may consist of checking the status of the flag associated with the interrupt number. In response to determining that the interrupt is not masked, at block 604, the flag may be set to indicate that the interrupt is masked.

In an embodiment, at block 606, the instantaneous time value may be read from a counter, counter 404 or 504 for example. In an embodiment, where the same interrupt coalescing time is associated with all the interrupts, a data word may be generating by concatenating the interrupt number with the read instantaneous time value. The portion of the data word corresponding to the read instantaneous time value may be referred to as the time-stamp. Generating the data word may be referred to as time-stamping the interrupt number. The resulting data word may be stored at the end of FIFO memory 408, for example.

In the embodiment, where different interrupt coalescing times are associated with different interrupt lines, at block 606, the interrupt coalescing time that corresponds to the number of the received interrupt, may be retrieved from interrupt coalescing time look up table (LUT) 506. As previously discussed, the interrupt number may be utilized as an index into the interrupt coalescing time look up table (LUT) 506 to retrieve the interrupt coalescing time. A data word may be generated by first adding the interrupt coalescing time with the instantaneous time value read from the counter. The result also referred to as the time to interrupt may then be concatenated with the interrupt number. The resulting data word may be stored in an empty entry of memory array 508, in an embodiment. In another embodiment, a data structure may be allocated and the resulting data word may be stored in the allocated data structure. The data structure may be appended to an existing memory array 508, if previously received interrupts are pending. At block 606, if memory array 508 contains other data words, the memory array 508 may be sorted based on the value the time to interrupt, as previously discussed.

In an embodiment, the size of the memory array 508 can be changed and additional data structures can by dynamically allocated and de-allocated according to system requirements. In an embodiment, in response to detecting the assertion of an interrupt line, a suitable data structure may be allocated and a reference to the allocated data structure may be added to memory array 508. The format of the data structure may conform to the format of the above described data word. After the interrupt is signaled to the host system using the above discussed interrupt-coalescing scheme, the data structure may be de-allocated or freed. Thus, the memory array 50 can be dynamically sized to account for changes in interrupt assertion activity. In the embodiment, for example, a system with several active interrupt sources would have a larger allocated memory array than a system with relatively fewer active interrupt sources.

At block 608, a data word stored in the first entry of FIFO array 408 or memory array 508 may be retrieved. In the embodiment of FIG. 4, the portion of the data corresponding to the time stamp may be retrieved at block 608. In this embodiment, the time stamp may be added with the interrupt coalescing time value stored in IRQ coalescing period register 414 to generate a time to interrupt value. The addition may be performed by the adder 410 of FIG. 4.

With reference to the embodiment of FIG. 5, at block 608, the portion of the data word corresponding to the time to interrupt may be extracted. Extraction of the portion of the data word corresponding to the time to interrupt may be effectuated by logically masking using the bi-wise AND operator the portion of the data word corresponding to the interrupt number. The result of the masking operation may be appropriately shifted, bit-wise left shifted for example, to recover the time stamp, i.e. the instantaneous value of the counter 504 when the interrupt was received at block 602.

At block 610, the time to interrupt previously computed in case of the embodiment of FIG. 4 or extracted in case of the embodiment of FIG. 5, may be compared with the instantaneous time value read from counter 404 or 504, respectively. The comparison operation may be performed by comparator 412 or 512, for example. If the result of comparison indicates that the instantaneous time value exceeds the time to interrupt, an interrupt may be generated and communicated to the host device 102 via bus interface 106.

By way of example and without limitation, in an embodiment, a method corresponding to the flow diagram of FIG. 6 may be implemented in a multi-tasking environment such as one provided by a real-time operating system executing by processor 208, for example. In this embodiment, a first task may perform the functionality ascribed to blocks 602 to 606. The data word corresponding to the time-stamped interrupt number may be posted to a software queue. A second task may perform the functionality ascribed to blocks 608 to 610.

Advantageously, method 600 uses a single free running counter to coalesce interrupts from any number of sources. When implemented in the embodiment of FIG. 4, method 600 uses a single free running counter 404 to delay the communication of a generated interrupt to host device 102. The time period of the delay is communicated by the host device 102 and stored in the IRQ coalescing period register 414. Additionally, after receiving an interrupt, the method 600 aggregates repeated reception of the interrupt for the time period specified in the IRQ coalescing period register 414. Thus, the host device 102 is notified only once about the occurrence of an interrupt, even though multiple assertions of the interrupt are detected during the IRQ coalescing time period.

Method 600 when implemented in the embodiment of FIG. 5 also uses a single free running counter to coalesce interrupts from any number of sources. Importantly, by employing using a LUT to store interrupt coalescing time periods for respective interrupts or groups of interrupts, method 600 enables different interrupts to be coalesced for different time periods. In an embodiment, an interrupt which occurs with a high degree of periodicity may be coalesced for a longer time period. On the other hand, an interrupt which occurs intermittently or infrequently, may be coalesced for a shorter time period. In another embodiment, a higher priority interrupt may be coalesced for a shorter time period, while a lower priority interrupt may be coalesced for a longer time period. In this embodiment, host device 102 may be alerted after a smaller period of time after when a higher priority interrupt is detected than when a lower priority interrupt is detected.

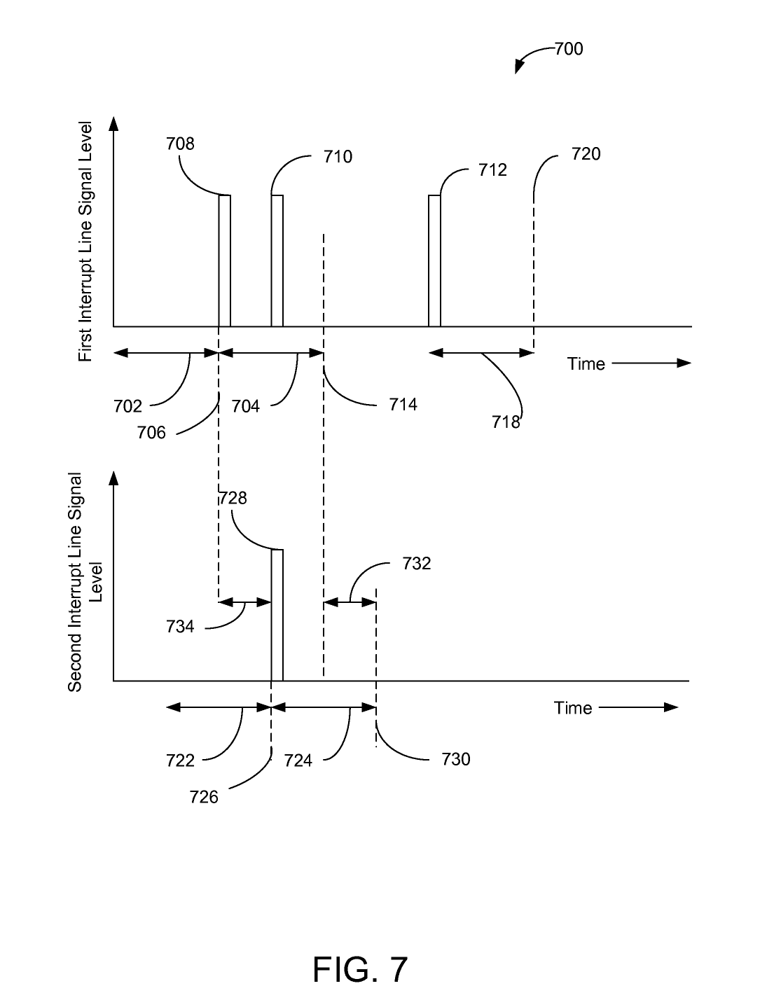

FIG. 7 is a timing diagram 700 that illustrates the previously described interrupt coalescing scheme where occurrences of a first and second interrupt are coalesced by the same time period. The signal level of a first interrupt line, 218-1 for example, is depicted on the vertical or Y-axis and time is represented on the horizontal or X-axis of the upper graph. The signal level of a second interrupt line, 218-2 for example, is depicted on the vertical or Y-axis and time is represented on the horizontal or X-axis of the lower graph. Time periods 702, 704, 722 and 724 correspond to the IRQ coalescing time period that may be received from host device 102. At time 706 interrupt signal corresponding to interrupt 218-1 is asserted. The assertion may be reflected as a pulse 708. In the illustrated scenario, because the interrupt signal was not asserted in the preceding IRQ coalescing time period 702, the interrupt is not masked. At approximately time 706, a data word that includes the interrupt number may be generated. As previously explained, the data word may include a value corresponding to time 706. In the embodiment of FIG. 4, where a common IRQ coalescing time period is associated with all the interrupts, the value may correspond to the instantaneous time value read from timer 404.

The generated data word may be stored in a queue, such as FIFO 410 or memory array 508. Subsequent assertion of the interrupt 218-1 depicted as pulses 710 is not acted on because the interrupt 218-1 is masked. At time 714, the interrupt is generated and communicated to the host device 102, for example. The difference between time 706 and time 714 is approximately equal to the IRQ coalescing time period. At about time 714, the interrupt is unmasked. A subsequent assertion of the interrupt indicated by pulse 712 is delayed by a time period 718 corresponding to the IRQ coalescing time period and is communicated to the host device 102 at time 720. The interrupt is masked during the time period 718.

At time 726 interrupt signal corresponding to interrupt 218-2 is asserted. The assertion may be reflected as a pulse 728. In the illustrated scenario, because the interrupt signal was not asserted in the preceding IRQ coalescing time period 722, the interrupt 218-2 is not masked. Temporally, assertion of interrupt 218-2 occurs after the assertion of interrupt 218-1 indicated by time period 734. At approximately time 726, a data word that includes the interrupt number of interrupt signal may be generated. As previously explained, the data word may include a value corresponding to time 726. In the embodiment of FIG. 4 where a common IRQ coalescing time period is associated with all the interrupts, the value may correspond to the instantaneous time value read from timer 404.

The generated data word may be stored in a queue, FIFO 410 or memory array 508. At time 730, the interrupt number of interrupt 218-2 is communicated to the host device 102, for example. The difference between the time 730 when the interrupt number of interrupt 218-2 is communicated to the host device 102 and the time 726 when the interrupt line 218-2 is asserted corresponds to the interrupt coalescing time period 702. The time difference 732 between the time 730 when the interrupt number of interrupt 218-2 is communicated to the host device 102 and the time 714 when the interrupt number of interrupt 218-1 is communicated to the host device 102 is approximately equal to time period 734, the time difference between the assertion of interrupt 218-1 and 218-2. In the foregoing discussion of FIG. 7, pulses 708, 710 and 712 correspond to a series of assertions of interrupt 218-1, where pulses 708 and 710 occur during interrupt coalescing time period 704.

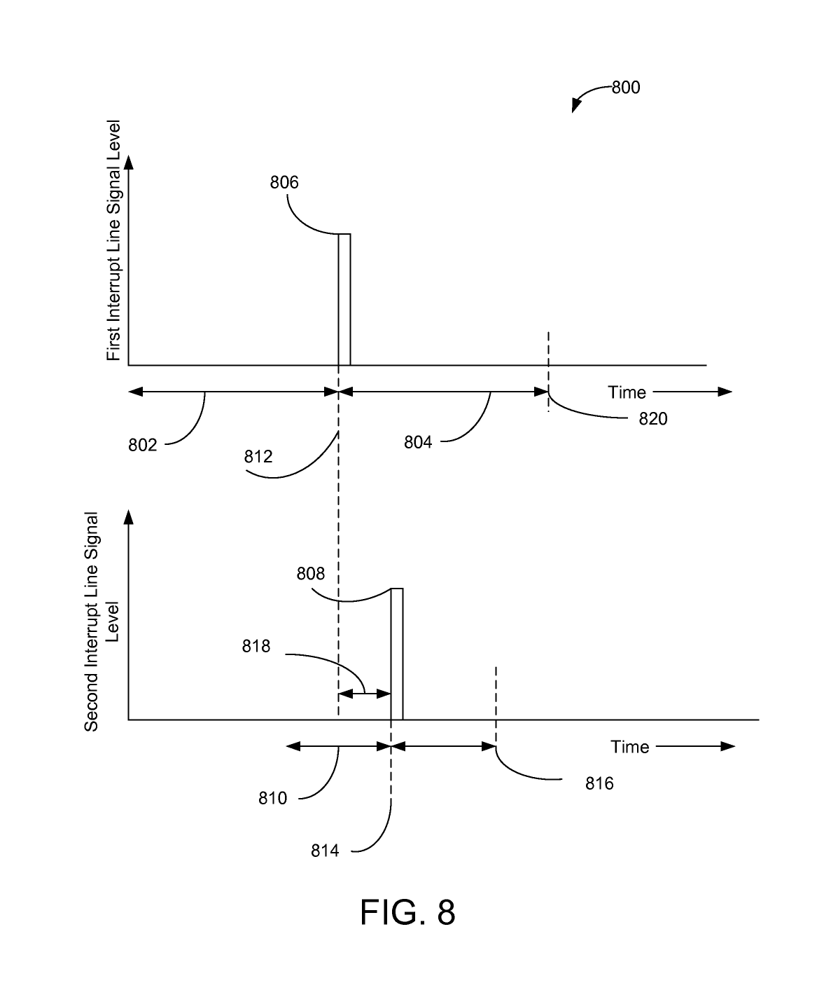

FIG. 8 is a timing diagram that illustrates an interrupt coalescing scheme where occurrences of a first and second interrupt, 218-1 and 218-2 for example, are coalesced by different coalescing time periods 802 and 810, respectively. The signal level of a first interrupt line, 218-1 for example, is depicted on the vertical or Y-axis and time is represented on the horizontal or X-axis of the upper graph. The signal level of a second interrupt line, 218-2 for example, is depicted on the vertical or Y-axis and time is represented on the horizontal or X-axis of the lower graph.

The timing diagram 800 may correspond to the embodiment of FIG. 5. Interrupt coalescing time period 802 associated with interrupt 218-1 is greater than coalescing time period 810 associated with interrupt 218-2. At time 812 interrupt signal corresponding to interrupt 218-1 is asserted. The assertion may be reflected as a pulse 806. In the illustrated scenario, because the interrupt signal was not asserted in the preceding IRQ coalescing time period 802, the interrupt is not masked. At approximately time 812, a data word that includes the interrupt number may be generated. In the embodiment of FIG. 5 where different respective IRQ coalescing time periods are associated with the interrupts, the data word may include a value that comprises the instantaneous time value read from counter 504 and the IRQ coalescing time period 802. This value may be referred to as the time to interrupt. The IRQ coalescing time period 802 may be retrieved from interrupt coalescing time LUT 506. The generated data word may be stored in memory array 508. The interrupt 218-1 may be masked after the generated data word is stored in memory array 508. Thus subsequent assertions of interrupt line 218-1 during a subsequent time period 804 corresponding to IRQ coalescing time period 802 will be disregarded.

At time 814, interrupt signal corresponding to interrupt 218-2 is asserted. The assertion may be reflected as a pulse 808. Time period 818 is the intervening time period between the assertion of interrupts 218-1 and 218-2. In the illustrated scenario, because the interrupt signal 218-2 was not asserted in the preceding IRQ coalescing time period 810, the interrupt is not masked. At approximately time 814, a data word that includes the interrupt number corresponding to may be generated. As previously explained, the interrupt number may be generated by the interrupt encoder and interrupt mask unit 502. In the embodiment of FIG. 5 where different respective IRQ coalescing time periods are associated with the interrupts, the data word may include a value that comprises the instantaneous time value read from counter 504 and the IRQ coalescing time period 810. The IRQ coalescing time period 810 may be retrieved from interrupt coalescing time LUT 506. The generated data word may be stored in memory array 508. The interrupt 218-2 may be masked after the generated data word is stored in memory array 508. Thus subsequent assertions of interrupt line 218-2 during a subsequent time period corresponding to IRQ coalescing time period 816 will be disregarded.

In an embodiment, at approximately time 814, the data words stored in the memory array 508 may be sorted. The data words may be sorted in based on the respective their time to interrupt value. The data word with the smallest time to interrupt, in this case data word corresponding to interrupt signal 218-2 is located at the first entry of memory array 508. This is because although interrupt signal 218-2 was asserted before interrupt signal 218-2, the sum of the time period 818 and IRQ coalescing time period 810 or 816 is less than IRQ coalescing time period 802.

At time 816, after a time period corresponding to IRQ coalescing time period 810, interrupt number corresponding to interrupt signal 218-2 may be communicated to the host device 102. As previously explained, comparator 512 may compare the time to interrupt value of the first data word with the instantaneous time value read from counter 504. If the time to interrupt value is greater than or equal to the read the instantaneous time value, interrupt number corresponding to interrupt signal 218-2 may be communicated to the host device 102. At time 816, the data word located in the first entry of memory array 508 may be deleted or removed and the data words in the memory array 508 may be advanced.

At time 820, after a time period corresponding to IRQ coalescing time period 802, interrupt number corresponding to interrupt signal 218-1 may be communicated to the host device 102.

Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional exemplary structures described but cover all relevant memory structures within the spirit and scope of the invention as described herein and as understood by one of skill in the art.

Further embodiments are contemplated, including combinations or sub-combinations of the above disclosed embodiments. The block diagrams of the architecture and flow diagrams are grouped for ease of understanding. However, it should be understood that combinations of blocks, additions of new blocks, re-arrangement of blocks, and the like are contemplated.

We claim:

1. A method for interrupt coalescing comprising:
performing in control circuitry of a peripheral device:
reading a first time value from a free-running counter when an assertion of a first interrupt is detected, the first time value corresponding to a detection time of the first interrupt;
reading a second time value from the free-running counter when an assertion of a second interrupt from a different interrupt source than the first interrupt is detected, the second time value corresponding to a detection time of the second interrupt;
communicating an identifier of the first interrupt to a host device when an instantaneous time read from the free-running counter is equal to or greater than a sum of the first time value and an interrupt coalescing time period; and
communicating an identifier of the second interrupt to the host device, when an instantaneous time read from the free-running counter is equal to or greater than a sum of the second time value and the interrupt coalescing time period.

2. The method of claim 1, further comprising generating the identifier of the first interrupt in response to detecting the assertion of the first interrupt.

3. The method of claim 2, further comprising generating the identifier of the second interrupt in response to detecting the assertion of the second interrupt.

4. The method of claim 1, further comprising retrieving the interrupt coalescing time period.

5. The method of claim 1, further comprising generating a first data word comprising the identifier of the first interrupt and the first time value.

6. The method of claim 5, further comprising generating a second data word, the second data word comprising the identifier of the second interrupt and the second time value.

7. The method of claim 6, further comprising storing the first data word in a first entry of a memory.

8. The method of claim 7, further comprising storing the second data word in a second entry of the memory.

9. The method of claim 8, further comprising retrieving the first data word from the memory, extracting the first time value from the first data word and computing the sum of the first time value and the interrupt coalescing time period.

10. The method of claim 9, further comprising retrieving the second data word from the memory, extracting the second time value from the second data word and computing a sum of the second time value and the interrupt coalescing time period.

11. A method comprising:
determining a first instantaneous time value from a counting circuit of a peripheral device when a first of a series of assertions of a first interrupt line is detected;
transmitting an identifier corresponding to a first interrupt after a first time period from detecting the first of the series of assertions of the first interrupt line;
determining a second instantaneous time value from the counting circuit when a first of a series of assertions of a second interrupt line is detected, wherein the first and second interrupt lines represent different interrupt sources; and
transmitting an identifier corresponding to a second interrupt after a second time period from detecting the first of the series of assertions of the second interrupt line, wherein the first time period is different from the second time period.

12. The method of claim 11, further comprising:
retrieving the first time period corresponding to the identifier of the first interrupt from a first entry of a lookup table containing a plurality of time periods; and
retrieving the second time corresponding to the identifier of the second interrupt period from a second entry of the lookup table.

13. The method of claim 12, further comprising:
generating a first data word comprising the identifier of the first interrupt and a sum of the first instantaneous time value and the first time period, wherein the sum of the first instantaneous time value and the first time period corresponds to a first interrupt generation time; and
storing the first data word in a first entry of a memory array.

14. The method of claim 13, further comprising:
generating a second data word comprising an identifier of the second interrupt and a sum of the second instantaneous time value and the second time period, wherein the sum of the second instantaneous time value and the second time period corresponds to a second interrupt generation time; and
storing the second data word in a second entry of the memory array.

15. The method of claim 14, further comprising sorting the first data word and the second data word in increasing order magnitude of the first interrupt generation time and the second interrupt generation time.

16. A peripheral device configured to be coupled to a host device, the peripheral device comprising:
a memory; and
an interrupt management unit (IMU) comprising a free-running counter, an interrupt encoding unit, an adder and an interrupt generation unit wherein:
the interrupt encoding unit is configured to detect a first of a series of assertions of a first interrupt line and a first of a series of assertions of a second interrupt line;
the adder is configured to read a first instantaneous time value from the free-running counter when the first of the series of assertions of the first interrupt line is detected by the interrupt encoding unit and read a second instantaneous time value from the free-running counter when the first of the series of assertions of the second interrupt line is detected; and
the interrupt generation unit is configured to generate a first interrupt after a first time period from the detection the first of the series of assertions of the first interrupt line and a second interrupt after a second time period from detecting the first of the series of assertions of the second interrupt line.

17. The peripheral device of claim 16, wherein the interrupt encoding unit is further configured to mask detection of assertions of the first interrupt line in response to detecting the first of the series of assertions of the first interrupt line.

18. The peripheral device of claim 17, wherein the interrupt encoding unit is further configured to mask detection of assertions of the second interrupt line in response to detecting the first of the series of assertions of the second interrupt line.

19. The peripheral device of claim 18, wherein the interrupt generation unit is further configured to unmask the detection of assertions of the first interrupt line after generating the first interrupt and unmask the detection of assertions of the second interrupt line after generating the second interrupt.

20. The peripheral device of claim 19, wherein the memory comprises three dimensional non-volatile memory.
